(19) United States
(12) Patent Application Publication
(10) Pub. No.: US 2019/0176314 A1
(43) Pub. Date: Jun. 13, 2019

(54) POWER TOOL AND ITS TRANSMISSION SHAFT

(71) Applicant: Jeff LIU, Taichung City (TW)

(72) Inventor: Jeff LIU, Taichung City (TW)

(21) Appl. No.: 15/835,883

(22) Filed: Dec. 8, 2017

(51) Int. Cl. B25D 17/26; B25D 9/00

(52) U.S. Cl. CPC B25D 17/26; B25D 9/00

(57) ABSTRACT

A power tool mainly includes a main body and a transmission shaft. The transmission shaft includes: a main body, including a driving section, an acting section and an axle body section between the driving section and the acting section, the driving section to be defined inside the main body in a rotary style; an axial channel, defined inside the main body; a first radial oil-filling channel, defined on the driving section of the main body, the first radial oil-filling channel connected to the axial channel, and the first radial oil-filling channel connected to the internal space of the main body preset to be lubricated; and a second radial oil-filling channel, defined on the acting section of the main body, the second radial oil-filling channel connected to the axial channel, and the second radial oil-filling channel goes out of the periphery of the acting section to form an oil-filling hole.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a partial structure of a power tool, and more particularly to an innovative design of the oil filling structure of the transmission shaft of a power tool.

### 2. Description of Related Art Including Information Disclosed Under 37 CFR 1.97 and 37 CFR 1.98

Due to the structural design of a transmission shaft, like one in a power tool, it is necessary to apply lubrication oil on the driving section of the transmission shaft as well as the corresponding position on the power tool hammer frame, so as to lubricate the hammering component and keep a long lifecycle of the power tool. Along with the continuous use of the power tool, the lubrication oil inside will lose gradually. Therefore, after a certain period of usage, the lubrication oil inside the power tool should be replenished.

Thus, to overcome the aforementioned problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The present invention of “a power tool and its transmission shaft” features an innovative and unique structural design constituted by the axial channel, first radial oil-filling channel and second radial oil-filling channel etc. Based on the innovative structure and technical characteristics, the invention makes an improvement on the prior-art structure in that, when it is needed to add lubrication oil to the transmission shaft, there is no longer a necessity to disassemble the power tool. Therefore, the usage is more convenient and efficient. Moreover, it can effectively avoid the problem of dirt accumulation and block of the oil-filling portion. It is indeed a practical inventive step.

### BRIEF DESCRIPTION OF THE SEVERAL VIEWS OF THE DRAWINGS

FIG. 1 is a perspective view of a preferred embodiment of the transmission shaft structure of the present invention.

FIG. 2 is a sectional view of a preferred embodiment of the transmission shaft structure of the present invention.

FIG. 3 is a schematic view of a preferred embodiment with disposition of the transmission shaft of the present invention in a power tool.

FIG. 4 is an embodiment view with the first radial oil-filling channel and second radial oil-filling channel of the present invention disposed on different sides.

FIG. 5 is a usage status view 1 of the present invention.

FIG. 6 is a usage status view 2 of the present invention.

### DETAILED DESCRIPTION OF THE INVENTION

Preferred embodiments of the present invention of a power tool and its transmission shaft are disclosed in FIGS. 1 to 3. However, it is to be understood that such embodiments are illustrative only and is not intending to limit the scope of patent claims in any manner. The power tool comprises a main body 80 and a main body A. Said main body A is defined inside the main body 80 in a rotary style, and said main body A is provided with an axial channel 40, a first radial oil-filling channel 60 and a second radial oil-filling channel 70.

Said main body 80 comprises an enclosure 81 and a grab handle 82 connected to the bottom of the enclosure 81. A hammer frame 83 is housed inside the internal space of the enclosure 81.

Said main body A comprises a driving section 10, an acting section 20 and a axle body section 30 between the driving section 10 and the acting section 20. Said driving section 10 is to be fit into the hammer frame 83 inside the main body 80 in a rotary style, and the acting section 20 relatively extends out of the main body 80.

Said axial channel 40 is defined inside the main body A and extends along the axial direction of the main body A. Said axial channel 40 comprises an internal end 41 and an external end 42. In particular, the internal end 41 extends out of the end face of the driving section 10, while the external end 42 extends to the inside of the acting section 20.

Said first radial oil-filling channel 60 is defined at a position on the driving section 10 of the main body A and extends along the radial direction. The internal end of the first radial oil-filling channel 60 and the axial channel 40 are intersected and connected to each other; while the external end the first radial oil-filling channel 60 is connected to the internal space (such as the hammer frame 83 of the main body 80) of the power tool preset to be lubricated.

Said second radial oil-filling channel 70 is defined at another position on the acting section 20 of the main body A and extends along the radial direction. The internal end of the second radial oil-filling channel 70 and the axial channel 40 are intersected and connected to each other, while the external end of the second radial oil-filling channel 70 extends out of the periphery of the acting section 20 to form an oil-filling hole 71.

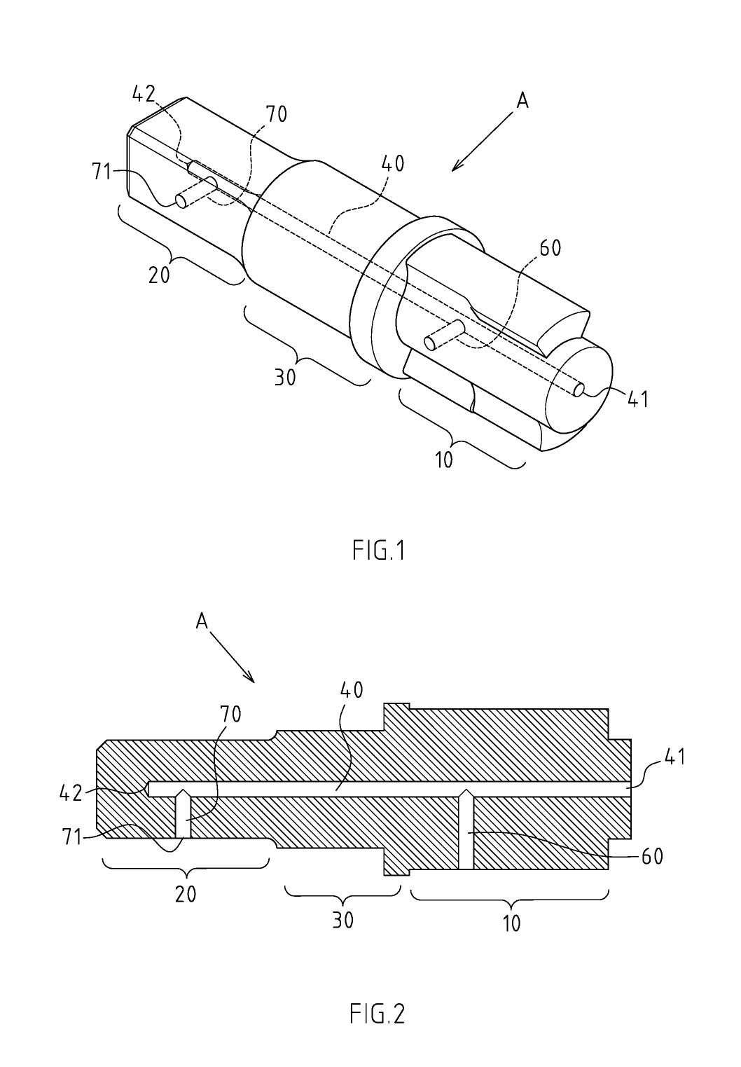

Referring to FIG. 2, in the embodiment, the first radial oil-filling channel 60 and the second radial oil-filling channel 70 are disposed on the same side.

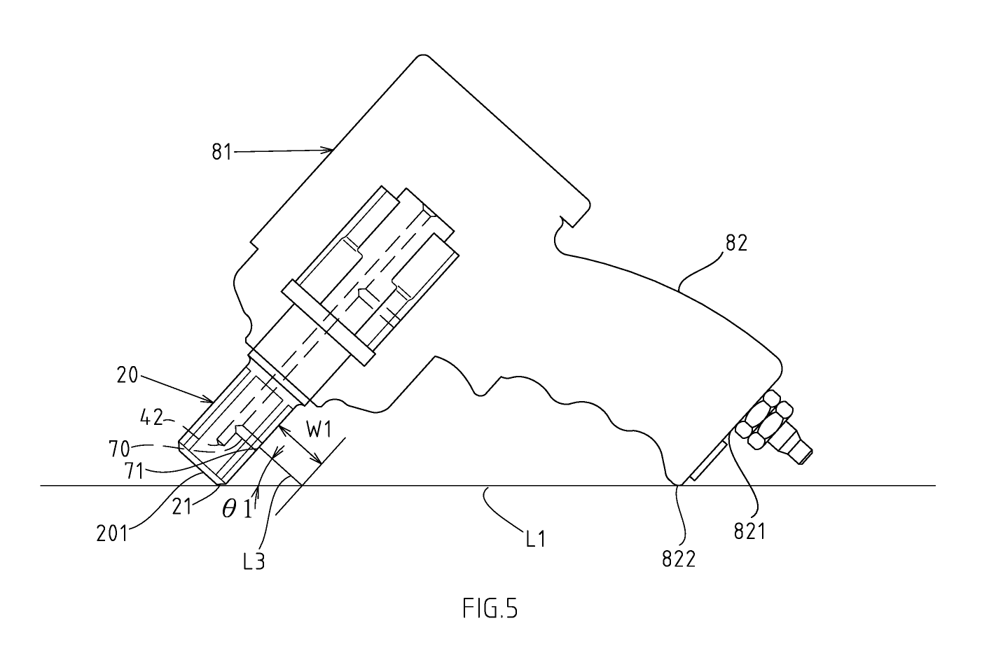

Referring to FIG. 4, in the embodiment, the first radial oil-filling channel 60 and the second radial oil-filling channel 70 are disposed on different sides.

Referring to FIG. 5, in the embodiment, between the corner 21 on the periphery of the free end 201 of the acting section 20 adjacent to the bottom portion of the grab handle 82, and the corner 822 on the bottom end 821 of the grab handle 82 adjacent to the free end 201 of the acting section 20, a projection plane L1 is defined, so that there is a distance W1 between the oil-filling hole 71 and the projection plane L1, and an included angle θ1 is formed between the projection plane L1 and the extended axial line L3 of the second radial oil-filling channel 70. Said included angle θ1 is less than 90 degrees. When the projection plane L1 of the main body 80 touches the ground surface, wall surface or other objects, because the oil-filling hole 71 does not contact the projection plane L1, the oil-filling hole 71 will not directly contact the ground surface, wall surface or other objects and dust contamination can be avoided.

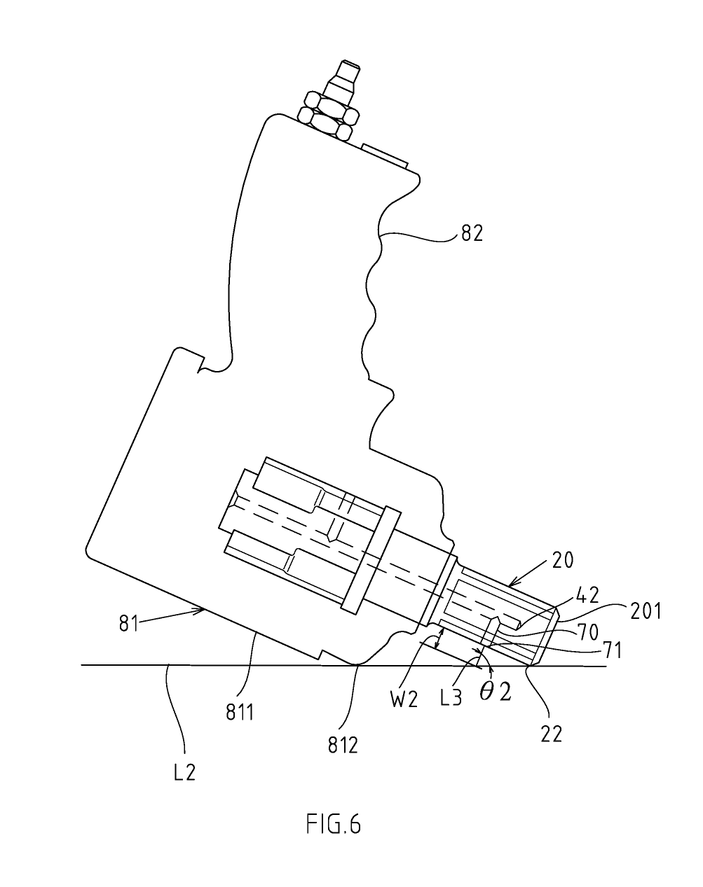

Referring to FIG. 6, in the embodiment, between the other corner 22 on the periphery of the free end 201 of the acting section 20 adjacent to the top portion of the enclosure 81, and the corner 812 on the top portion 811 of the enclosure 81 adjacent to the free end 201 of the acting section 20, a projection plane L2 is defined, so that there is distance W2 between the oil-filling hole 71 and the projection plane L2, and an included angle θ2 is formed between the projection plane L2 and the extended axial line L3 of the second radial oil-filling channel 70. Said included angle θ2 is less than 90 degrees. When the projection plane L2 of the main body 80 touches the ground surface, wall surface or other objects, because the oil-filling hole 71 does not contact the projection plane L2, the oil-filling hole 71 will not contact the ground surface, wall surface or other objects and dust contamination can be avoided.

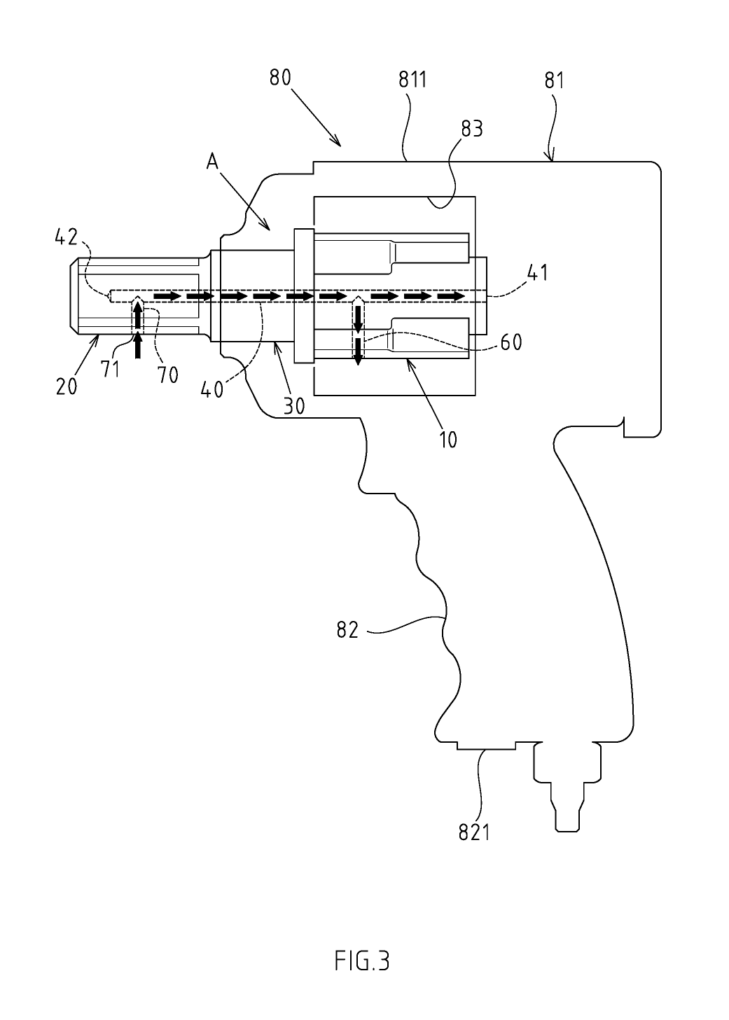

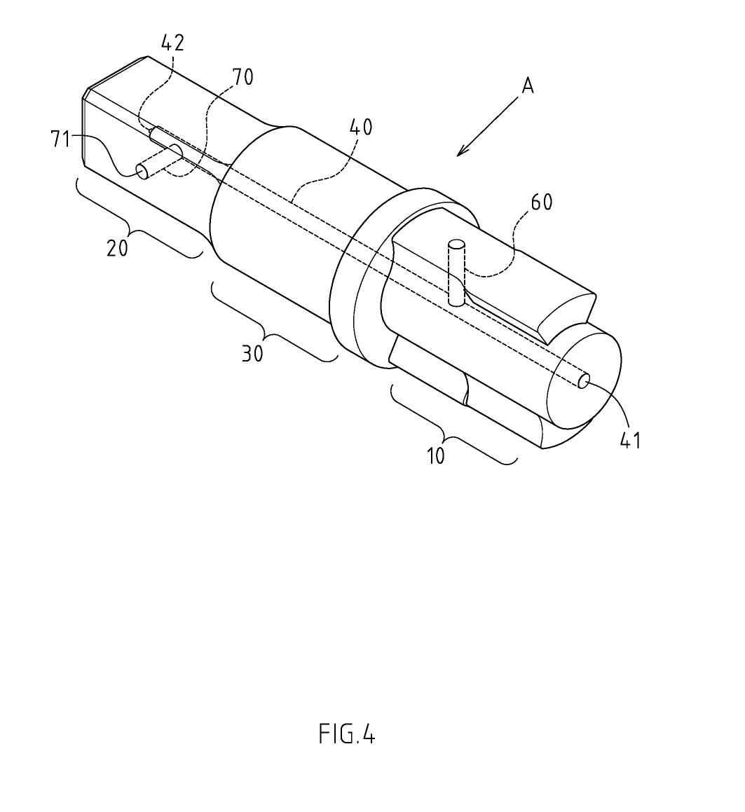

Based on said structural constitution and technical characteristics, the practical application of the transmission shaft of a power tool as disclosed in the present invention is depicted in FIG. 3. In this embodiment, the main body A is a transmission shaft of a main body 80. Its driving section 10 is extending into the inside of the main body 80, so that the external end of the first radial oil-filling channel 60 is connected to the hammer frame 83 of the main body 80 preset to be lubricated. When the user wants to fill lubrication oil into the hammer frame 83, the flow path is as indicated by the thick solid arrow in the drawing. Firstly, lubrication oil is filled from the oil-filling hole 71. Then, in sequence, it goes through the second radial oil-filling channel 70, the internal end 41 of the axial channel 40 and the first radial oil-filling channel 60, and finally into the hammer frame 83. In this way, the lubrication oil can be replenished easily and quickly. Also, it is to be noted that, thanks to the unique design of the first radial oil-filling channel 60, the oil-filling hole 71 is not located on the end face of the acting section 20 but on a lateral position, thus, chances of external dust contamination can be significantly reduced. Moreover, even if the oil-filling hole 71 happens to be contaminated with dust, when the main body A rotates, thanks to the radial extending form of the first radial oil-filling channel 60, the internal lubrication oil and dust will be thrown out of the oil-filling hole 71 by the centrifugal force generated by the rotation of the main body A. Thus, the oil-filling hole 71 can be automatically cleaned. This is an unexpected advantage over the prior art.

I claim:

1. A transmission shaft of a power tool, said transmission shaft comprising:
a main body, including a driving section, an acting section and a axle body section between the driving section and the acting section, said driving section is to be installed inside a power tool in a rotary style, and said acting section relatively extends out of the power tool;
an axial channel, defined inside the main body and extending along the axial direction of the transmission shaft, said axial channel comprising an internal end and an external end, wherein said internal end extends out of the end face of the driving section, and said external end extends to the inside of the acting section;
a first radial oil-filling channel, defined on a position of the driving section of the main body and extending along the radial direction, with the internal end of said first radial oil-filling channel and said axial channel intersected and connected to each other, and the external end of said first radial oil-filling channel connected to the internal space of the power tool preset to be lubricated; and
a second radial oil-filling channel, defined at another position on the acting section of the main body and extending along the radial direction, with the internal end of said second radial oil-filling channel internal end and said axial channel intersected and connected to each other, and the external end of said second radial oil-filling channel external end extending out of the periphery of the acting section to form an oil-filling hole.

2. The structure defined in claim 1, wherein said first radial oil-filling channel and second radial oil-filling channel are disposed on the same side.

3. The structure defined in claim 1, wherein said first radial oil-filling channel and second radial oil-filling channel are disposed on different sides.

4. A power tool, comprising:
a main body, comprising an enclosure and a grab handle connected to the bottom of the enclosure, with a hammer frame housed inside the internal space of the enclosure; and
a transmission shaft, comprising:
a main body, comprising a driving section, an acting section and a axle body section between the driving section and the acting section, wherein said driving section is to be fit into the hammer frame in a rotary style, and said acting section relatively extends out of the main body;
an axial channel, defined inside the main body and extending along the axial direction of the transmission shaft, said axial channel comprising an internal end and an external end, wherein said internal end extends out of the end face of the driving section, while said external end extends to the inside of the acting section;
a first radial oil-filling channel, defined at a position on the driving section of the main body and extending along the radial direction, with the internal end of said first radial oil-filling channel and said axial channel intersected and connected to each other, while the external end of said first radial oil-filling channel connected to the hammer frame; and
a second radial oil-filling channel, defined at another position on the acting section of the main body and extending along the radial direction, with the internal end of said second radial oil-filling channel and said axial channel intersected and connected to each other, while the external end of said second radial oil-filling channel external end extending out of the periphery of acting section to form an oil-filling hole.

5. The structure defined in claim 4, wherein, between the corner on the periphery of the free end of the acting section adjacent to the bottom portion of the grab handle, and the corner on the bottom end of the grab handle adjacent to the free end of the acting section, a projection plane is defined, so that there is a distance between the oil-filling hole and the projection plane, and an included angle is formed between the projection plane and the extended axial line of the second radial oil-filling channel; said included angle is less than 90 degrees; between the other corner on the periphery of the free end of the acting section adjacent to the top portion of the enclosure, and the corner on the top portion of the enclosure adjacent to the free end of the acting section, a projection plane is defined, so that there is a distance between the oil-filling hole and the projection plane, and an included angle is formed between the projection plane and the extended axial line of the second radial oil-filling channel; said included angle is less than 90 degrees.

6. The structure defined in claim 4, wherein said first radial oil-filling channel and second radial oil-filling channel are disposed on the same side.

7. The structure defined in claim 4, wherein said first radial oil-filling channel and second radial oil-filling channel are disposed on different sides.
